(19) United States
(12) Patent Application Publication
(10) Pub. No.: US 2007/0001087 A1
(43) Pub. Date: Jan. 4, 2007

(54) Webcam clip

(76) Inventors: San-Wuei Shyu, Taipei (TW); Shih-Chao Huang, Taipei (TW); Hsien-Ru Chu, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/169,706

(22) Filed: Jun. 30, 2005

(51) Int. Cl. A47G 29/00; F16M 11/00

(52) U.S. Cl. 248/688

(57) ABSTRACT

A webcam clip is disclosed. The webcam is a U-shaped frame with a clipping part and a pivoting part formed by bent metal wire with certain wire diameter. The clipping part makes the present invention easily clip on edges of panels while the pivoting part is formed by two rear ends of the U-shaped frame for being disposed on a first concave hole arranged symmetrically on right and left sides of a housing of webcam so as to form a pivot between the U-shaped frame and the housing. Therefore, the angles of lens are adjustable. Moreover, a guiding slot is arranged above the first concave hole for connecting the first concave hole with a second concave hole so as to make the pivoting part of the clip elastically move from the first concave hole to the second concave hole along the guiding slot and the device is in folded form. Or the pivoting part can move in reverse direction, from the second concave hole to the first concave hole, along the guiding slot for being used. Thus the clip for webcam has simplified structure that is easy to be used or stored. With compact design, the storage space is saved and the device is easy to carry.

### BACKGROUND OF THE INVENTION

The present invention relates to a webcam clip, especially to a webcam clip clipped on a housing of webcam so as to adjust angles of lens and easily set up, or carry the webcam. Due to popularity of internet communication, the network camera (also called webcam, or PC camera) has become a common equipment for users. Most of people set the webcam above the monitor or LCD (liquid crystal display) panels of computers so as to make the lens face users. However, the thickness of the panels is thin. For example, the thickness of ASUS notebooks ranges from 8 mm to 14 mm. Thus it is difficult to set up the webcam with adjustable lens firmly on the panel. Especially notebooks are portable so that the webcam also need to have features with portability, compact, convenient set-u, and easy adjustment. But the webcam available now can't match above requirements.

### SUMMARY OF THE INVENTION

Therefore it is a primary object of the present invention to provide a webcam clip that uses a bent metal to form a U-shaped frame with a clipping part and a pivoting part. The clipping part makes the present invention easily clip on edges of panels while the pivoting part formed by two ends of the U-shaped frame. The pivoting part can be disposed on a first concave hole arranged symmetrically on right and left sides of a housing of webcam so as to form a pivot between the U-shaped frame and the housing. Therefore, the angles of lens are adjustable. The webcam is not only easy to set up but also convenient for adjusting lens.

It is another object of the present invention to provide a webcam clip that having a guiding slot connecting a first concave hole on a housing of the webcam and a second concave hole so as to make the pivoting part of the clip elastically move from the first concave hole to the second concave hole along the guiding slot. Then the clip is pivoted and is attached on the housing, become into folded form. Or the pivoting part can move in reverse direction, from the second concave hole to the first concave hole, along the guiding slot for being used. Thus the clip for webcam has features of easy assembling, compact volume, conveniently folding and easy carry.

It is further object of the present invention to provide a webcam clip that is made by a bent metal wire with certain wire diameter so as to simplify the structure and reduce the manufacturing cost. Thus the device can be mass-produced.

It is further object of the present invention to provide a webcam clip that has a plastic or rubber covering on the supporting and loading surface of metal wire of the clipping part as well as pivoting part for enhancing clipping effect of the clipping part as well as pivoting part.

### BRIEF DESCRIPTION OF THE DRAWINGS

FIG. 1 is a perspective view of an embodiment in accordance with the present invention;

FIG. 2 is an explosive view of the embodiment in FIG. 1;

FIG. 3 is a side view of the embodiment in FIG. 1;

FIG. 4 is a perspective view showing the present invention disposed on a computer panel;

FIG. 5 is a side view of the embodiment in FIG. 4;

FIG. 5A is a partial enlarged view of the embodiment in FIG. 5;

FIG. 6 is a perspective view showing the embodiment of the present invention in folded form;

FIG. 7 is a side view of the embodiment in FIG. 6.

### DETAILED DESCRIPTION OF THE PREFFERED EMBODIMENT

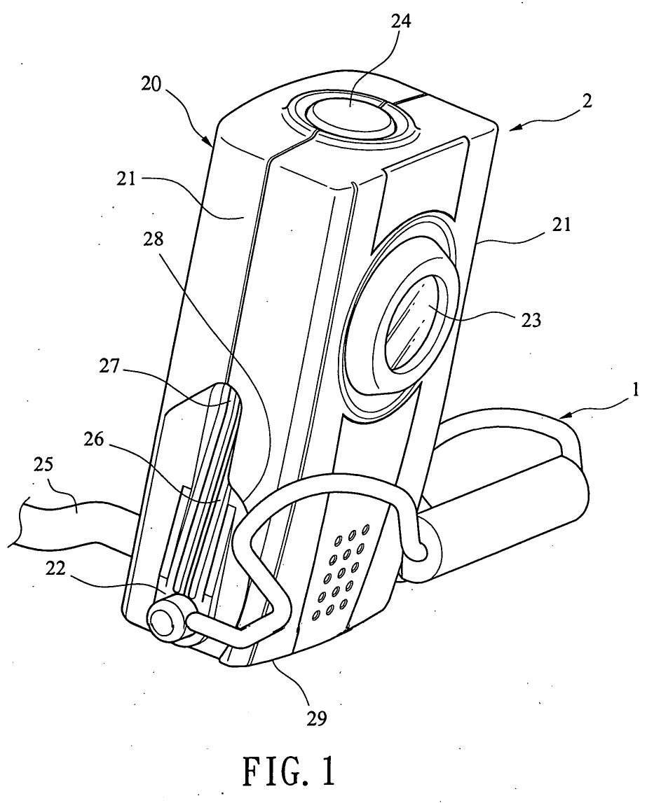

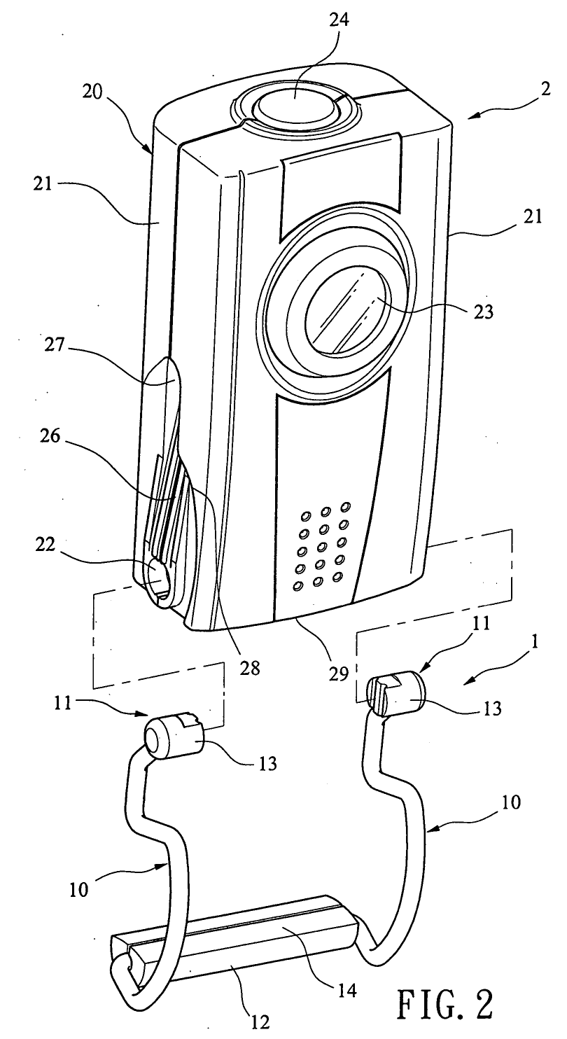

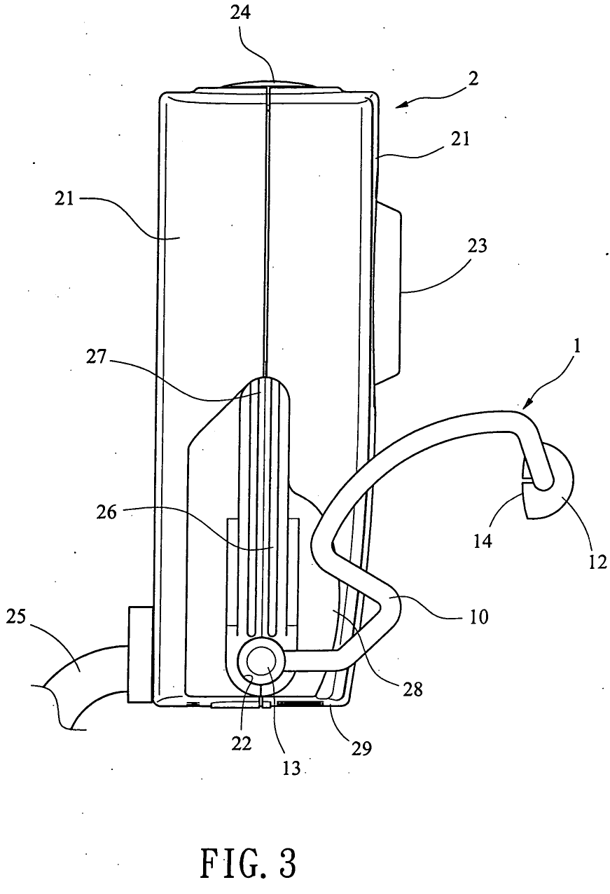

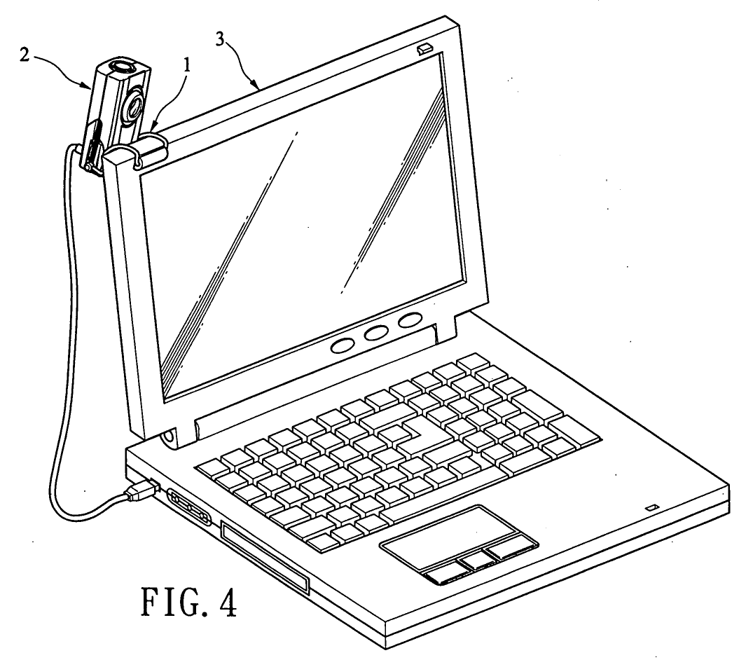

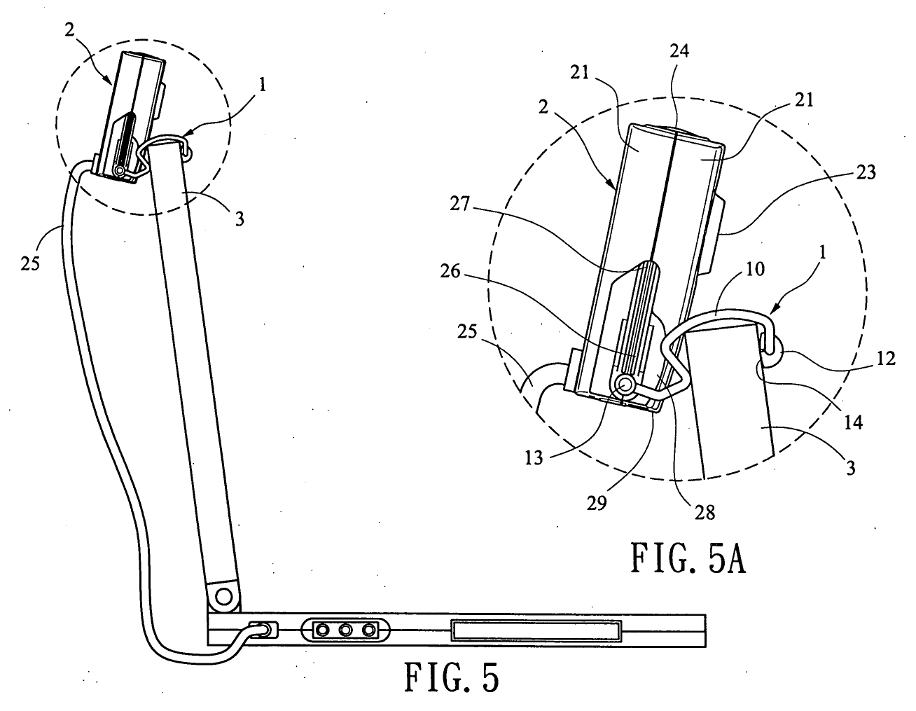

Refer to FIG. 1, FIG. 2 & FIG. 3, a webcam clip 1 in accordance with the present invention is used in combination with a webcam 2. A clip 1 is a U-shaped frame that is formed by bending a metal wire with certain wire diameter. The clip 1 consists of a clipping part 10 and a pivoting part 11. The clipping part 10 is symmetrically disposed on right and left sides of the U-shaped frame. The width of the clipping part 10 fits the thickness of a panel 31 of a computer 3 so that the clip 1 is installed on edges of the panel 31 by the clipping part 10, as shown in FIG. 4, FIG. 5, & FIG. 5A. Moreover, the pivoting part 11 is symmetrically arranged on two ends of the left and right sides of the metal U-shaped frame. When being used, the pivoting part 11 is clipped on a first concave hole 22 positioned symmetrically in left and right sides 21 of a housing 20 of the webcam 2 so as to form a pivot between the U-shaped clip 1 and the webcam 2. Therefore, shooting angle of lens 23 of the webcam 2 is adjustable, as shown in FIG. 5 & FIG. 5A.

A covering 12, 13 is arranged on bottom of the metal U-shaped frame of the clip 1 or rear end of the pivoting part 11 respectively. The covering 12, 13 is made by plastic or rubber and is integrated with the clip 1 by injection modeling. Thus the clipping effect of the clipping part 10 and the pivoting part 11 is enhanced. The cross section 14 of the covering 12 can be semicircle so as to make the cross section 14 attached on the edge of the panel 31, as shown in FIG. 5, & FIG. 5A.

The webcam 2 generally is composed by a housing 20 with an image sensor, circuits, a lens 23, a shutter key and an external cable for connection with other devices such as USB cables connected with computer hubs. A first concave hole 22 is symmetrically disposed on right and left sides 21 of the housing 20, near the bottom thereof. Furthermore, a guiding slot 26 is arranged on right and left sides 21 of the housing 20, above the first concave hole 22, and is connected to a second concave hole 27. Thus by the flexibility of the metal wire, the pivoting part 11 with the covering 13 of the clip 1 moves from the first concave hole 22 to the second concave hole 27 along the guiding slot 26.

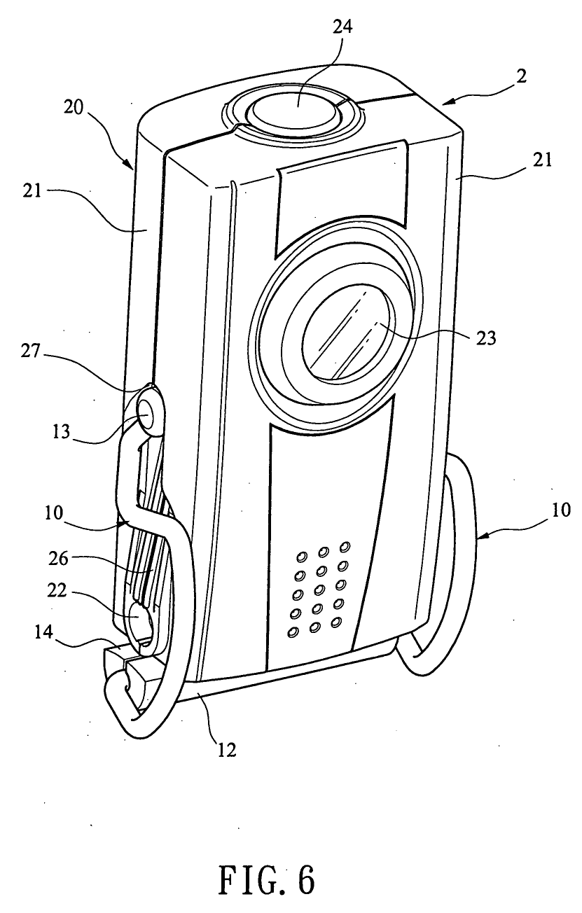

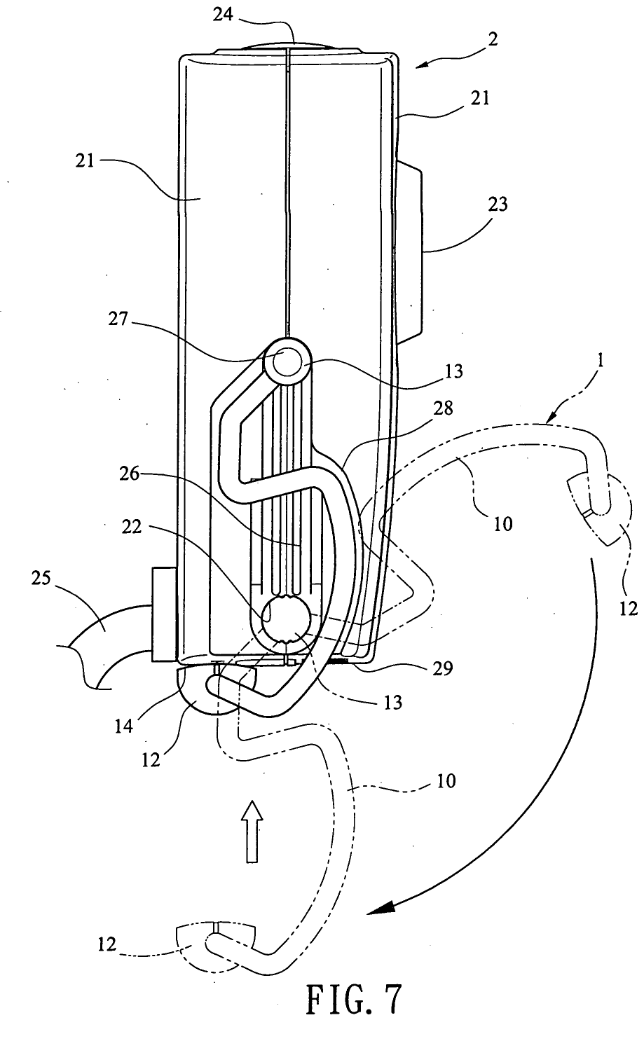

The device is in folded form, as shown in FIG. 6 & FIG. 7. When being used, the pivoting part 11 moves in reverse direction, from the second concave hole 27 to the first concave hole 22, along the guiding slot 26. Therefore, it is easy to use or arrange the webcam 2.

Refer to FIG. 1 & FIG. 7, the above first concave hole 22, the guiding slot 26, and the second concave hole 27 are all arranged on a large groove 28 of the left and right sides 21. The shape of the groove 28 corresponds to the shape of the left and right sides of U-shaped frame of the clip 1 so that the left and right sides of U-shaped frame of the clip 1 can mount inside the groove 28 after the clip 1 being pivoted, as the arrowhead pointed in FIG. 7. The bottom of the U-shaped frame of the clip 1 (the covering 12) also attaches on the bottom 29 of the housing 20. Thus the webcam 2 is in folded form, as shown in FIG. 6, & FIG. 7. Therefore the webcam 2 has features with simple structure, convenient set up, compact design and portability.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents

What is claimed is:

1. A webcam clip that is a U-shaped frame for being assembled with a housing of a webcam comprising a clipping part and a pivoting part,
wherein the clipping part is symmetrically on right and left sides of the U-shaped frame and the width of the clipping part fits the thickness of a panel of a computer so that the clip is installed on edges of the panel by the clipping part;
the pivoting part is formed symmetrically by rear ends of left and right sides of the U-shaped frame for clipping on a first concave hole symmetrically disposed on left and right sides of the housing of the webcam so that a pivot is formed between the U-shaped clip and the webcam;
in accordance with above structure, the clip is assembled on and integrated with the housing of the webcam by the pivoting part and is clipped on edge of a panel of a computer to be in use status; angles of lens of webcams are adjustable due to the pivoting part.

2. The device as claimed in claim 1, wherein the clip is made by a bent metal wire.

3. The device as claimed in claim 1, wherein a covering with certain thickness is arranged on the bottom of the U-shaped frame of the clip.

4. The device as claimed in claim 2, wherein a covering with certain thickness is arranged on the bottom of the U-shaped frame of the clip.

5. The device as claimed in claim 3, wherein the covering is made by plastic or rubber and is integrated with the clip by injection modeling.

6. The device as claimed in claim 4, wherein the covering is made by plastic or rubber and is integrated with the clip by injection modeling.

7. The device as claimed in claim 3, wherein the covering having a semicircle cross section.

8. The device as claimed in claim 4, wherein the covering having a semicircle cross section.

9. The device as claimed in claim 1, wherein a covering with certain thickness is arranged on rear end of the metal wire of pivoting part on the U-shaped frame of the clip.

10. The device as claimed in claim 2, wherein a covering with certain thickness is arranged on rear end of the metal wire of pivoting part on the U-shaped frame of the clip.

11. The device as claimed in claim 9, wherein the covering is made by plastic or rubber and is integrated with the clip by injection modeling.

12. The device as claimed in claim 10, wherein the covering is made by plastic or rubber and is integrated with the clip by injection modeling.

13. The device as claimed in claim 1, wherein the first concave hole is symmetrically disposed on right and left sides of the housing of the webcam, near the bottom side thereof.

14. The device as claimed in claim 1, wherein a guiding slot is disposed above the first concave hole on right and left sides of the housing of the webcam for connecting the first concave hole with a second concave hole so as to make the pivoting part of the clip moves from the first concave hole to the second concave hole or in reverse direction along the guiding slot.

15. The device as claimed in claim 13, wherein a guiding slot is disposed above the first concave hole on right and left sides of the housing of the webcam for connecting the first concave hole with a second concave hole so as to make the pivoting part of the clip moves from the first concave hole to the second concave hole or in reverse direction along the guiding slot.

16. The device as claimed in claim 14, wherein the first concave hole, the guiding slot and the second concave hole on right and left sides of the housing of the webcam are all arranged inside a corresponding groove while the shape of the groove corresponds to the shape of the left and right sides of the U-shaped frame of the clip so that the left and right sides of U-shaped frame of the clip 1 can mount inside the groove after the clip being pivoted and the bottom of the U-shaped frame attaches on the bottom of the housing; thus the webcam is in folded status.

17. The device as claimed in claim 15, wherein the first concave hole, the guiding slot and the second concave hole on right and left sides of the housing of the webcam are all arranged inside a corresponding groove while the shape of the groove corresponds to the shape of the left and right sides of the U-shaped frame of the clip so that the left and right sides of U-shaped frame of the clip 1 can mount inside the groove after the clip being pivoted and the bottom of the U-shaped frame attaches on the bottom of the housing; thus the webcam is in folded status.
